(19) United States
(12) Patent Application Publication
(10) Pub. No.: US 2007/0046056 A1
(43) Pub. Date: Mar. 1, 2007

(54) CARGO BOX INNER FOR A VEHICLE

(75) Inventors: Ryan Anthony Delaney, Belleville, MI (US); A. Michael Paiva, Novi, MI (US); John Marcus Comiez, Farmington, MI (US); Mark Duane Hanson, Royal Oak, MI (US); Vincent Salvatore Anselmi, Sterling Heights, MI (US); Kristina Anne Reifert, Sterling Heights, MI (US); Patrick John Young, Waterford, MI (US); Shawn Michael Morgans, Chelsea, MI (US)

Correspondence Address: ARTZ & ARTZ, P.C., 28333 TELEGRAPH ROAD, SUITE 250, SOUTHFIELD, MI, 48034, US

(73) Assignee: FORD GLOBAL TECHNOLOGIES, LLC, Dearborn, MI (US)

(21) Appl. No.: 11/163,447

(22) Filed: Oct. 19, 2005

Related U.S. Application Data
(60) Provisional application No. 60/712,947, filed on Aug. 31, 2005.

(51) Int. Cl. B60R 9/00

(52) U.S. Cl. 296/37.6

(57) ABSTRACT

A cargo box inner (12) for a vehicle (10) is provided. The cargo box inner (12) is comprised of a series of interconnected composite panels (22, 24a, 24b, 26) that form a cargo bed (14). One or more pairs of these panels (22, 24a, 24b, 26) are each joined together for forming a storage bin (40a, 40b, 42) adjacent to the cargo bed (14). Each storage bin (40a, 40b, 42) is selectively covered by a lid (50, 64), which is movable between an open position and a closed position.

### CROSS-REFERENCE TO RELATED APPLICATION(S)

The present application claims priority to U.S. provisional patent application 60/712,947 filed Aug. 31, 2005, and is related to U.S. non-provisional application no. ______ filed on Oct. 19, 2005, and entitled “D-PILLAR STRUCTURE FOR A REAR VEHICLE BODY STRUCTURE” (Attorney Docket No. 81123725/FGT-2067), the disclosure of which is incorporated by reference herein.

### TECHNICAL FIELD

The present invention relates generally to vehicles, and more particularly to a cargo box inner that enhances the storage capacity of a vehicle.

### BACKGROUND

Cargo box inners (“cargo boxes”) typically are mounted to a vehicle frame between substantially vertical rear fenders or quarter panels. These cargo boxes usually define an open-top bed behind a passenger cabin of a truck. Accordingly, cargo boxes are also known as pickup boxes, truck boxes, pickup truck boxes, and truck bed boxes.

Traditional cargo boxes were comprised of up to forty (40) steel components, including panels with a thermoformed plastic liner. These steel components typically were welded together for defining a bed floor, two sidewalls, and a headboard.

Automotive manufacturers later developed a cargo box having a one-piece composite construction, which could be produced more quickly and at significantly lower costs than its steel counterpart. In addition, the composite box is substantially lightweight and has improved resistance to dents and corrosion.

Existing one-piece cargo boxes do not have additional storage bins or other compartments integrally formed therein adjacent to the bed.

Also, the typical one-piece box includes a floor portion and two sidewall portions that extend somewhat outboard from the floor portion. In this way, the cargo box can be removed from a mold after the box has been fabricated. Also, in this regard, the largest width of the cargo box typically is measured between the top ends of the opposing sidewall portions. In other words, the floor portion does not extend across as much of the available space between the outer sidewall fenders as the top ends of the sidewall portions. It is understood that a larger-sized floor portion can increase the storage capacity of the vehicle.

It would therefore be desirable to provide a cargo box having a robust construction with an enhanced storage capacity and a low manufacturing cost associated therewith.

### SUMMARY OF THE INVENTION

A cargo box inner for a vehicle is provided. The cargo box inner is comprised of a series of interconnected composite panels that form a cargo bed. Two or more of these panels define a storage bin adjacent to the cargo bed. Each storage bin is selectively covered by a lid that is movable between an open position and a closed position.

One advantage of the invention is that a cargo box inner is provided that increases the storage capacity of a vehicle.

Another advantage of the invention is that a cargo box inner is provided that has generally fewer components and is thus manufactured within shorter cycle times and at substantially lower costs.

Yet another advantage of the invention is that a cargo box inner is provided that has a modular construction with components that can be efficiently packaged for storing and/or shipping large volumes of the components at lower costs.

Still another advantage of the invention is that a cargo box inner is provided that has a modular construction that can be quickly repaired with minimized costs associated therewith.

Yet another advantage of the invention is that a cargo box inner is provided that has a lightweight construction for improving the fuel economy of a vehicle.

Still another advantage of the invention is that a cargo box inner is provided that has a robust construction for supporting high-load cargo and resisting dents and corrosion.

Other advantages of the present invention will become apparent upon considering the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of the examples of the invention:

FIG. 1 is a rear perspective view of a vehicle having a cargo box inner, according to one advantageous embodiment of the claimed invention.

FIG. 2 is a partially exploded view of the vehicle shown in FIG. 1, illustrating the cargo box inner attached to a vehicle frame between a pair of rear fenders.

FIG. 3 is a fully exploded view of the cargo box inner shown in FIG. 1, illustrating the cargo box inner having a modular construction comprised of individual composite panels.

FIG. 4 is a cross-sectional view of the vehicle shown FIG. 1, as taken along line 4-4, illustrating the cargo box inner having a side bin.

FIG. 5 is cross-sectional view of the cargo box inner shown in FIG. 1, as taken along line 5-5, illustrating the cargo box inner having a forward bin.

FIG. 6 is a top view of the cargo box inner shown in FIG. 1, illustrating the cargo box inner having a forward bin extending substantially across a width of the box.

FIG. 7A is a perspective cross-sectional view of the forward bin shown in FIG. 5 illustrating the load-bearing structure of the lid.

FIG. 7B is an enlarged view of the piano hinge shown in FIG. 7A, as taken within circle 7B.

FIG. 8 is a perspective view of the cargo box inner shown in FIG. 1, as taken along arrow 8, illustrating a sidewall panel having a handle mounted therein for opening a storage bin.

FIG. 9 is a rear perspective view of the vehicle shown FIG. 1, illustrating the vehicle with a cover attached thereon for covering the cargo box inner and securing cargo therein.

### DETAILED DESCRIPTION OF THE INVENTION

In the following figures, the same reference numerals are used to identify the same components in the various views.

The present invention is particularly suited for a cargo box inner (“cargo box”) for an open-top bed of a vehicle, such as a sports utility vehicle (“SUV”). Accordingly, the embodiments described herein employ structural features where the context permits.

However, various other embodiments are contemplated having different combinations of the described features, having additional features other than those described herein, or even lacking one or more of those features. For instance, the cargo box can be integrated within a pickup truck having an open-top bed, a luxury SUV having an enclosed rear cargo bay, an SUV having a retractable roof over its cargo bay, or other suitable vehicles. Thus, the claimed invention can be carried out in a variety of other modes and utilized for other suitable applications as desired.

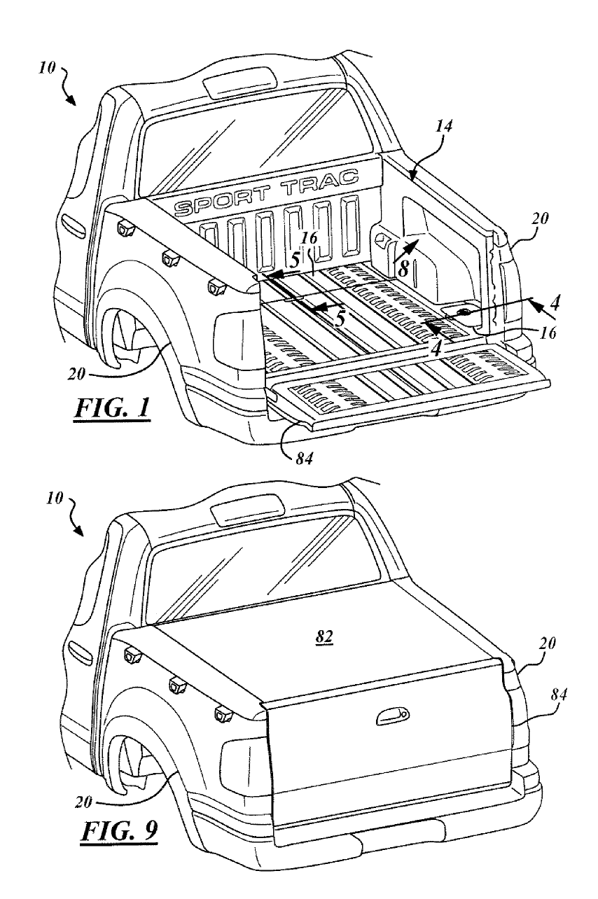

Referring now to FIG. 1, there is shown a perspective view of an SUV 10 having a cargo box 12, according to one advantageous embodiment of the claimed invention. As detailed below, the cargo box 12 provides a substantially large cargo bed 14 and a series of storage compartments 16 for enhancing the storage capacity of the SUV 10.

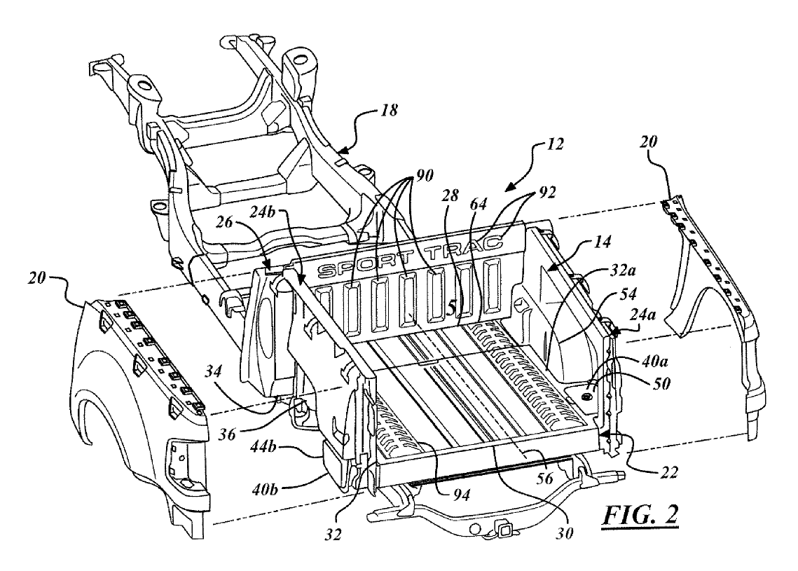

As shown in FIG. 2, the cargo box 12 is mounted to a vehicle frame 18 of the SUV 10 between a pair of vertical rear fenders 20. In this regard, the rear fenders 20 define the width of the packaging constraints within which the cargo box 12 can be installed.

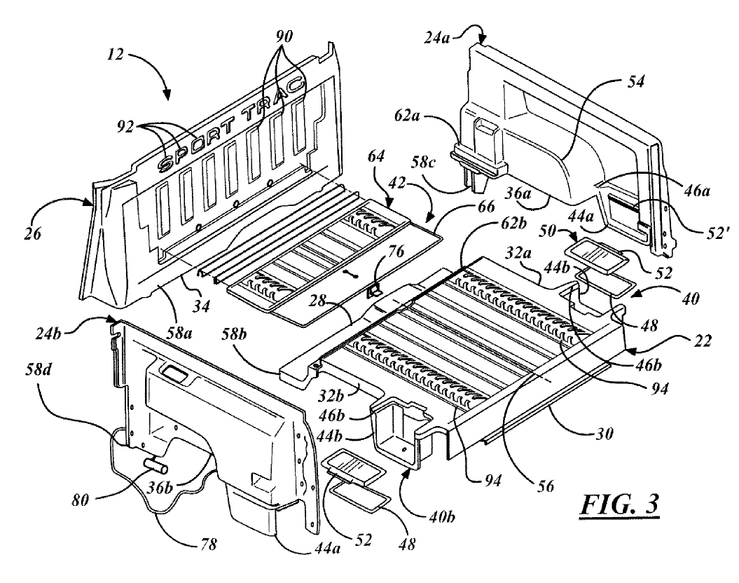

Referring to FIG. 3, there is shown a fully exploded view of the cargo box 12 illustrated in FIG. 2. This cargo box 12 has a modular construction comprised of individual composite panels. The composite panels primarily include a floor panel 22, a pair of sidewall panels 24a, 24b, and a headboard panel 26. This construction is beneficial at least for the reason that a damaged panel can be repaired or replaced within a substantially short period of time and at generally low costs.

Further, each composite panel is comprised of sheet molding compound (“SMC”). In that regard, it will be appreciated that the cargo box 12 has a substantially strong and lightweight construction that is resistant to corrosion and dents. However, the composite panels can be comprised of various other suitable materials as desired so long as they fulfill the purposes of the present invention.

Also, one or more of these composite panels has structures therein, which could not otherwise be formed in a one-piece composite box. For instance, the headboard panel 26 has substantially thick reinforcement ribs 90 and a series of recesses 92 for displaying the name of a vehicle trim level. It is understood that all of the composite panels can have the ribs 90 formed therein. Also, one or more of the panels can have recesses or other suitable structures for displaying a symbol, a word, a letter, a number, or a trademark as desired.

By way of another example, the floor panel 22 has tire-tread texture 94 formed therein. However, one or more panels can have the tire tread texture 94 or various other surface textures including a coarse-grain texture and a fine grain texture.

The floor panel 22 has a front portion 28, a rear portion 30, and a pair of opposing side portions 32a, 32b. The front portion 28 of the floor panel 22 is attached to a bottom portion 34 of the headboard panel 26. Moreover, the opposing side portions 32a, 32b of the floor panel 22 are attached to lower portions 36a, 36b of the opposing sidewall panels 24a, 24b. This construction is secured by a series of bolt fasteners and adhesive bonding. However, other suitable fastening means can be utilized as desired.

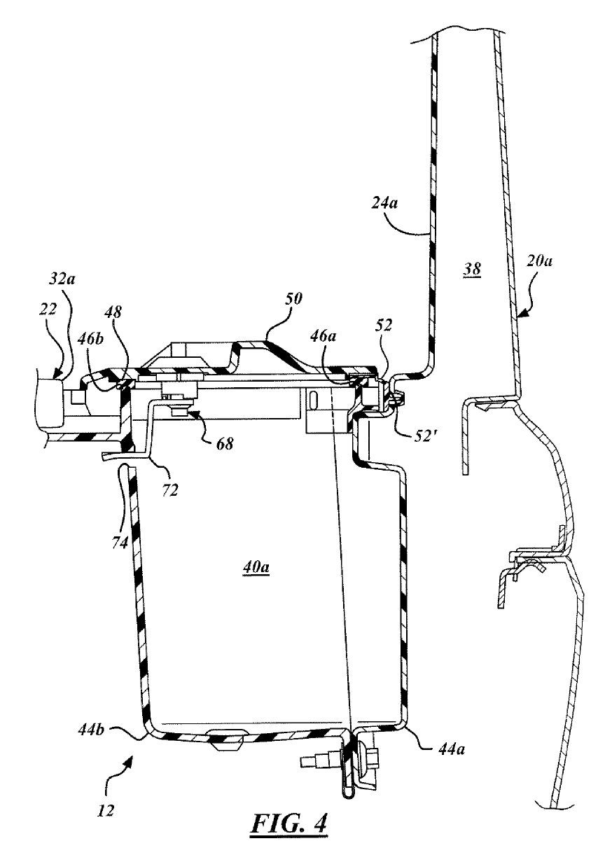

The floor panel 22 has a substantially wide construction for enhancing the storage capacity of the cargo box 12. Specifically, as exemplified in FIG. 4, each sidewall panel 24a, 24b extends substantially perpendicularly from the floor panel 22. In that regard, the floor panel 22 is sized substantially wide within the packaging constraints defined by the rear fenders 20a, 20b. In other words, the cavity 38 between each sidewall panel 24a, 24b and its respective fender 20a, 20b is minimized for increasing the width of the floor panel 22.

One skilled in the art will appreciate that otherwise extending the sidewall panels 24a, 24b outboard from the floor panel 22 can increase the width of the cavity 38. Accordingly, this construction would decrease the width of the floor panel 22 and the storage space within the predetermined packaging restraints.

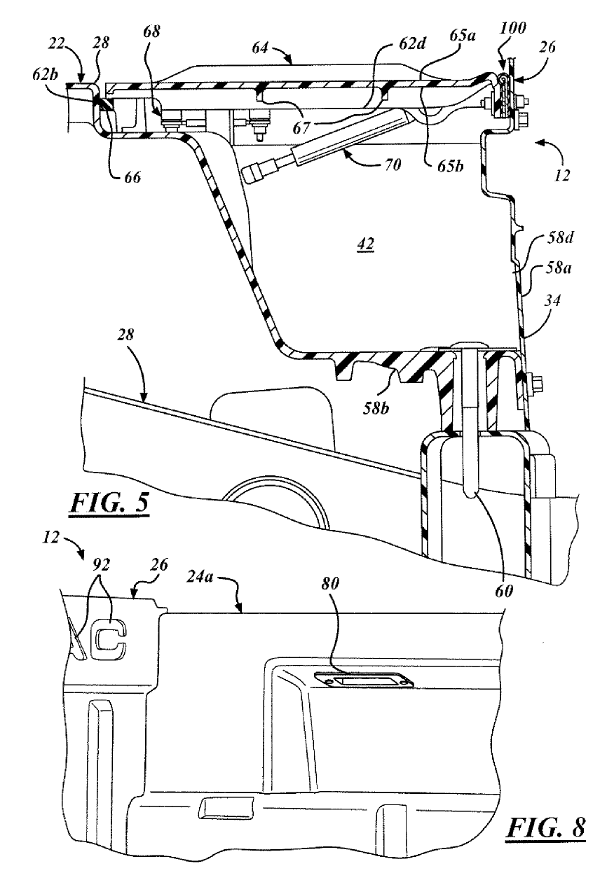

As introduced in FIG. 1, the cargo box 12 further includes one or more storage bins 16 for enhancing the storage capacity of the SUV 10. In this embodiment, the storage bins 16 include a pair of side bins 40a, 40b (as exemplified in FIG. 4) and a forward bin 42 (as exemplified in FIG. 5). However, it is contemplated that the cargo box 12 can instead have more or less than three storage bins that are located in a variety of suitable locations.

With specific attention to FIG. 4, the side bin 40a is defined by the floor panel 22 and the sidewall panel 24a. In particular, the floor panel 22 and the sidewall panel 24a each have a side-bin structure 44a, 44b respectively formed therein for joining together and forming the side bin 40a. It is understood that the side-bin structures 44a, 44b can be recesses within the respective panels 22, 24a or other suitable structures as desired.

In this embodiment, each side-bin structure 44a, 44b includes a recessed seat 46a, 46b with a seal member 48 attached thereon. The recessed seats 46a, 46b are utilized for receiving and supporting a lid 50 pivotally attached to the sidewall panel 24a via a hinge member. For example, the lid 50 has an extruded rubber living hinge 52 extending therefrom for snap-fitting into an aperture 52′ formed in the sidewall panel 24a. The lid 50 is movable between an open position and a closed position, in which the lid 50 sealingly covers the side bin 40a with the seal member 48 sandwiched between the lid 50 and the recessed seats 46a, 46b.

Furthermore, each lid 50 is a load floor or load-bearing structure and thus provides additional surface area upon which cargo can be stored. Specifically, in the closed position, the lid 50 extends outboard from a periphery of the floor panel 22 and therefore increases the storage capacity of the SUV 10.

Moreover, as shown in FIG. 2, each side bin 40a, 40b and wheel housing 54 are offset from a longitudinal reference line 56 of the cargo box 12 by a substantially equal distance. In this respect, it is understood that the lid 50 is less likely to support higher-load cargo placed within the bed 14.

Referring now to FIGS. 5 and 6, the forward bin 42 is defined by forward-bin structures 58a, 58b, 58c, 58d respectively formed in the headboard panel 26, the floor panel 22 and the sidewall panels 24a, 24b. The forward-bin structures 58a, 58b, 58c, 58d are recesses but can instead be various other suitable structures as desired. Also, as best shown in FIG. 6, this forward bin 42 extends substantially across the width of the cargo box 12. It is contemplated that the forward bin 42 can have various suitable constructions.

With attention to FIG. 5, the forward-bin structure 58b of the floor panel 22 is a substantially thick recessed portion of the floor panel 22 for attachment to the vehicle frame 18 via a series of bolt fasteners 60. It is understood that other portions of the floor panel 22 or other composite panels can have localized thickened portions as desired.

In addition, the forward-bin structures 58b, 58c, 58d each have a recessed seat 62b, 62c, 62d for receiving and supporting a lid 64 pivotally attached to the headboard panel 26. The lid 64 is movable between an open position and a closed position, in which the lid 64 sealingly covers the forward bin 42 with the seal member 66 sandwiched between the lid 64 and the recessed seats 62b, 62c, 62d.

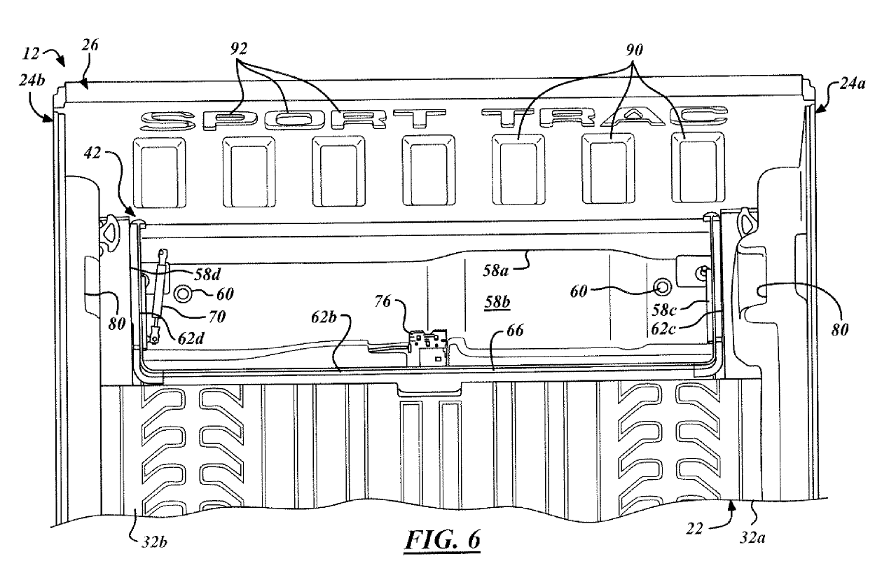

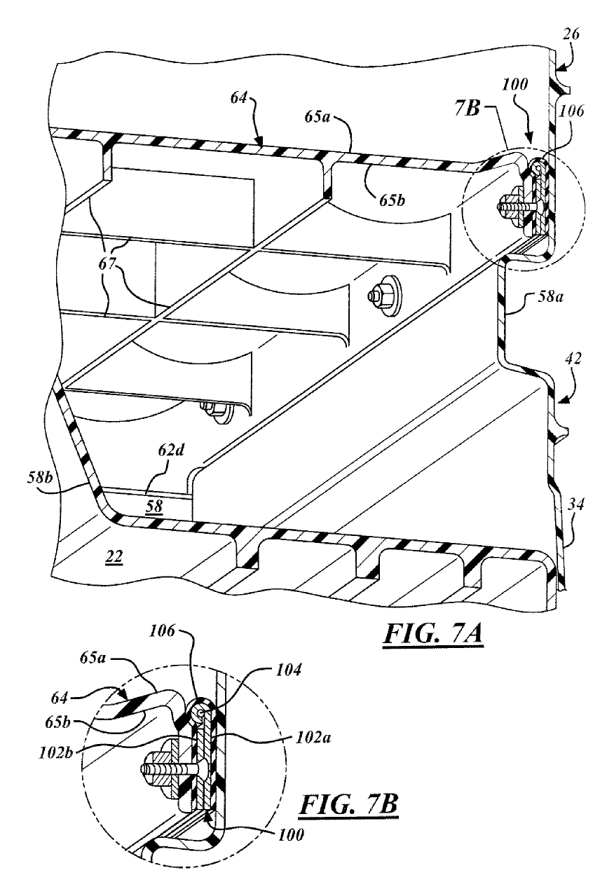

Furthermore, the lid 64 is a load floor or load-bearing structure that is sufficiently strong for supporting cargo thereon. In this embodiment, as best shown in FIG. 7A, the lid 64 has a top side 65a and a bottom side 65b with gussets 67 integrally formed therein. It is understood that the lid 64 can instead have other suitable reinforcement members or lack the same as desired.

In addition, referring to FIGS. 5 and 6, the lid 64 strengthens the overall front-end portion of the cargo box 12. Namely, the periphery of the lid 64 in its closed position is sandwiched between the floor panel 22, the sidewall panels 24a, 24b, and the headboard panel 26. In this way, the lid 64 bears a load transferred between the composite panels and stabilizes the cargo box 12. For example, in this embodiment, the lid 64 is pivotally attached to the headboard panel 26 substantially across its width via one or more piano hinges 100. The piano hinge 100 is comprised of opposing leaf plates 102a, 102b and a pin 104 coupled therebetween. Accordingly, the lid 64 in its closed position transfers a load through the leaf plates 102a, 102b and evenly distributes the load across a substantial portion of the headboard panel 26. In this embodiment, the piano hinge 100 also has a seal member 106 attached thereon for preventing water and other moisture in the bed 14 from seeping into the hinge 69 and the forward bin 42. It will be appreciated that the lid 64 can instead be pivotally attached to the headboard panel 26 and transfer loads thereto by various other suitable constructions.

Referring now to FIGS. 4 through 6, the cargo box 12 further includes a latch mechanism 68 (shown in FIG. 4) and a detent mechanism 70 (shown in FIGS. 5 and 6) for operating the respective lids 50, 64.

For instance, with respect to the side bin 40a shown in FIG. 4, the cargo box 12 includes a latch mechanism 68 comprising a rotatable locking arm 72 extending from the lid 50 and a hole 74 formed in the floor panel 22 for receiving the arm 72 and locking the lid 50 in a closed position. It is understood that the latch mechanism 68 can instead be other suitable latch mechanisms.

Regarding the forward bin 42 exemplified in FIGS. 5 and 6, the cargo box 12 includes a detent mechanism 70 which holds the lid 64 in its existing position whether the lid 64 is opened or closed. In this embodiment, the detent mechanism 70 is a gas strut device. However, it will be appreciated that the detent mechanism 70 can instead be other suitable devices.

Moreover, the lid 64 for the forward bin 42 is attached to a pawl cable latch 76 schematically shown in FIG. 3 for selectively releasing the lid 64 from the closed position. This pawl cable latch 76 is operated via a cable 78 attached to a handle 80 (shown in FIG. 8) that is mounted to the sidewall panel 24a.

Referring now to FIG. 9, there is shown the SUV 10 shown in FIG. 1 with a tonneau cover 82 secured across the top of the cargo box 12 and the tailgate 84 moved to a closed position. It will be appreciated that the storage bins are sufficiently positioned on the cargo box 12 for concealing and otherwise preventing access thereto when the cover 82 is installed on the cargo box 12. This construction is beneficial for safely storing possessions in the storage bins and minimizing the risk of theft.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

What is claimed is:

1. A cargo box inner for a vehicle, comprising:
a plurality of individual composite panels forming a cargo bed;
at least one pair of said composite panels defining a storage bin adjacent to said cargo bed; and
a lid movable between an open position and a closed position for covering said storage bin.

2. The cargo box inner recited in claim 1 wherein said plurality of composite panels comprises:
a floor panel having a front portion, a rear portion, and a pair of opposing side portions;
a pair of opposing sidewall panels attached to said pair of opposing side portions of said floor panel;
a headboard panel attached to said front portion of said floor panel;
said lid bearing a load transferred between at least one pair of said composite panels when said lid is moved to said closed position.

3. The cargo box inner recited in claim 2 wherein said lid is pivotally attached to one of said composite panels via a piano hinge member for distributing said load therebetween.

4. The cargo box inner recited in claim 2 wherein said lid has at least one reinforcement member extending therefrom.

5. The cargo box inner recited in claim 2 wherein a substantially large portion of said storage bin is defined by said floor panel.

6. The cargo box inner recited in claim 2 wherein said storage bin comprises a forward bin defined by said headboard panel, said floor panel, and said pair of opposing sidewall panels.

7. The cargo box inner recited in claim 6 wherein said forward bin extends substantially across the width of said floor panel.

8. The cargo box inner recited in claim 2 wherein said storage bin comprises a side bin that is defined by one of said sidewall panels and one of said side portions of said floor panel.

9. The cargo box inner recited in claim 8 wherein each of said sidewall panels has a wheel housing formed therein, said wheel housing and said side bin offset a substantially equal distance from a longitudinal reference line of the cargo box inner.

10. The cargo box inner recited in claim 2 wherein said pair of opposing sidewall panels extends substantially perpendicularly from said floor panel.

11. The cargo box inner recited in claim 1 wherein at least one of said composite panels has at least one reinforcing member comprising at least one of a rib and a locally thickened surface area.

12. The cargo box inner recited in claim 1 wherein at least one of said composite panels has at least one recess for displaying at least one of a letter, a word, a trademark, a symbol, and a number.

13. The cargo box inner recited in claim 1 wherein at least one of said composite panels has a textured surface comprising at least one of a fine-grained surface, a coarse-grained surface, and a tire-tread surface.

14. The cargo box inner recited in claim 1 wherein said lid has a living hinge member for attachment to one of said composite panels.

15. The cargo box inner recited in claim 1 wherein at least two of said composite panels have a recessed seat adjacent to said storage bin for supporting said lid.

16. The cargo box inner recited in claim 15 wherein said recessed seat and said lid in said closed position have a seal member sandwiched therebetween.

17. A cargo box inner for a vehicle, comprising:
plurality of individual composite panels forming a cargo bed;
at least one pair of said composite panels having a pair of mating bin structures for defining a storage bin adjacent to said cargo bed; and
at least one of said bin structures for attachment to a vehicle frame;
a lid movable between an open position and a closed position for covering said storage bin;
said plurality of individual composite panels including a floor panel, a headboard panel, and a pair of opposing sidewall panels;
said floor panel having a front portion, a rear portion, and a pair of opposing side portions;
said pair of opposing sidewall panels attached to said pair of opposing side portions of said floor panel;
said headboard panel attached to said front portion of said floor panel.

18. The cargo box inner recited in claim 17 further comprising:
at least one of an opening mechanism and a latch mechanism;
said opening mechanism moving said lid to said open position;
said detent mechanism for holding said lid in one of said open position and said closed position.

19. A vehicle with enhanced storage capacity, comprising:
a vehicle frame;
a bed structure coupled to said vehicle frame and comprised of a cargo box inner and a pair of outer sidewall fenders;
said cargo box inner comprised of a plurality of individual composite panels forming a cargo bed;
at least one pair of said composite panels having a pair of mating bin structures defining a storage bin adjacent to said cargo bed; and
at least one of said mating bin structures mounting said cargo box inner to said vehicle frame;
a lid movable between an open position and a closed position for covering said storage bin;
said plurality of individual composite panels including a floor panel, a headboard panel, and a pair of opposing sidewall panels;
said floor panel having a front portion, a rear portion, and a pair of opposing side portions;
said pair of opposing sidewall panels attached to said pair of opposing side portions of said floor panel;
said headboard panel attached to said front portion of said floor panel.

20. The cargo box inner recited in claim 19 wherein said lid is positioned between said opposing sidewall panels and is inaccessible from an exterior of the vehicle when said cargo box inner has a cover attached thereon with a tailgate of the vehicle moved to a shut position.
